(19) United States
(12) Patent Application Publication
(10) Pub. No.: US 2023/0420799 A1
(43) Pub. Date: Dec. 28, 2023

(54) BATTERY SEPARATOR FOR LITHIUM-ION BATTERIES

(71) Applicant: GLATFELTER CORPORATION, Charlotte, NC (US)

(72) Inventors: Christopher John JOWSEY, Lancaster, PA (US); David Amos Rittenhouse, Lillian, AL (US); Vishal BANSAL, Mechanicsburg, PA (US)

(73) Assignee: GLATFELTER CORPORATION, Charlotte, NC (US)

(21) Appl. No.: 18/342,672

(22) Filed: Jun. 27, 2023

Related U.S. Application Data
(60) Provisional application No. 63/355,807, filed on Jun. 27, 2022.

(51) Int. Cl. H01M 50/431; H01M 50/454; H01M 50/491; H01M 50/417; H01M 50/403; H01M 10/0525; H01M 50/451

(52) U.S. Cl. CPC H01M 50/431; H01M 50/454; H01M 50/491; H01M 50/417; H01M 50/403; H01M 10/0525; H01M 50/451

(57) ABSTRACT

Nonwoven battery separators, batteries comprising nonwoven battery separators, and methods of manufacturing nonwoven battery separators having improved durability and resilience for better in-service performance, more long-term durability, and safer battery products, wherein the nonwoven battery separator is coated with inorganic oxides.

### FIELD

This disclosure relates in general to improved nonwoven materials. In particular, this disclosure relates to nonwoven battery separators for use in lithium-ion batteries and methods of manufacturing said battery separators.

### BACKGROUND

Batteries have been utilized for many years as electrical power generators in remote locations. Through the controlled movement of electrolytes (ions) between electrodes (anode and cathode), a power circuit is generated, thereby providing a source of electricity that can be utilized until the electrolyte source is depleted and no further electrical generation is possible. In more recent years, rechargeable batteries have been created to allow for longer lifetimes for such remote power sources. All in all, however, the capability of reusing such a battery has led to greater potentials for use, particularly through, for example, handheld devices such as cell phones and laptop computers and, even more so, to the possibility of automobiles that require electricity to function.

Such batteries typically include at least five distinct components. A case (or container) that houses everything in a secure and reliable manner to prevent leakage to the outside as well as environmental exposure inside. Within the case are an anode and a cathode, separated effectively by a battery separator, as well as an electrolyte solution (e.g., low viscosity liquid) that transports through the battery separator between the anode and cathode. Rechargeable batteries can run the gamut of small and portable devices, with a great deal of electrical generation potential in order to remain effective for long periods between charging episodes, to vary large types present within automobiles, as an example, that include large electrodes (at least in surface area) that must not contact one another and large amounts of electrolytes that must consistently and constantly pass through a membrane to complete the necessary circuit, all at a level of power generation conductive to providing sufficient electricity to run an automobile engine. And with the further emergence of electrical automobiles, the expended demand for such batteries is only expected to grow. As such, the capability and versatility of battery separators in the future must meet certain requirements that have yet to be provided within the current industry.

Battery separators have been used since the advent of closed-cell batteries to provide necessary protection from unwarranted contact between electrodes as well as to permit effective transport of electrolytes within power generating cells. Typically, such materials have been of film structure, sufficiently thin to reduce the weight and volume of a battery device while imparting the necessary properties noted above at the same time. Such separators must exhibit other characteristics as well to allow for proper battery function. These include chemical stability, suitable porosity of ionic species, effective pore size for electrolyte transfer, proper permeability, effective mechanical strength (both during construction of the battery as well as in-service life), and the capability of retaining dimensional and functional stability when exposed to high temperatures (as well as the potential for shutdown if the temperature rises to an abnormally high level.).

Battery separator materials must be of sufficient strength and constitution to withstand several different scenarios. Initially, the separator must not suffer tears or punctures during the stresses of battery assembly. In this manner, the overall mechanical strength of the separator is extremely important, particularly as high tensile strength material in both the machine and cross directions allows the manufacturer to handle such a battery separator more easily and without stringent guidelines, so the battery separator does not suffer structural failure or loss during such a procedure. Additionally, from a chemical perspective, the battery separator must withstand the oxidative and reductive environment within the battery itself, particularly when fully charged. Any failure during use, specifically in terms of structural integrity permitting abnormally high amounts of electrolyte to pass or for the electrodes to touch, would destroy the power generation capability and render the battery totally ineffective. Thus, even above the ability to weather chemical exposure, such a separator must also not lose dimensional stability (i.e., warp or melt) or mechanical strength during storage, manufacture, and use, either, for the same reasons noted above.

At the same time, a battery separator must be of proper thickness to facilitate the high energy and power densities of the battery itself. A uniform thickness is quite important too to allow for a long-life cycle as any uneven wear on the battery separator will be the weak link in terms of proper electrolyte passage, as well as electrode contact prevention. The ability, however, to provide an extremely thin, uniform dimension, within such battery separators has proved to be rather difficult, particularly since a thickness reduction of an already thin structure tends to compromise separator strength.

Moreover, regarding pore size, battery separators must exhibit proper porosity and pore sizes to accord the proper transport of ions through such a membrane (as well as proper capacity to retain a certain amount of liquid electrolyte to facilitate such ion transfer during use). The pores themselves should be sufficiently small to prevent electrode components from entering and/or passing through the membrane, while also allowing for proper rate of transfer of electrolyte ions therethrough. As well, uniformity in pore sizes, as well as pore size distribution, provides a more uniform result in power generation over time as well as more reliable long-term stability for the overall battery as uniform wear on the battery separator allows for longer life cycles. It additionally can be advantageous to ensure the pores therein may properly close upon exposure to abnormally high temperatures to prevent excessive and undesirable ion transfer upon battery failure (e.g., preventing fires and other similar hazards). Thus, providing uniformly small pore sizes (and thus proper porosity measurements for such a purpose) within a thin, dense nonwoven structure has yet to be fully optimized. Film structures may be manufactured to certain dimensions, but porosity reductions are designed in such separators, rather than produced or at least modified through further treatments past initial manufacture. There remains a drive for low pore sizes to provide, for example, beneficial protections in terms of electrode contact, while maintaining sufficient durability and resilience to mechanical stresses.

Furthermore, the battery separator must not impair the ability of the electrolyte to completely fill the entire cell during manufacture, storage, and use. Thus, the battery separator must exhibit proper wicking and/or wettability during such phrases to ensure the electrolyte in fact may properly generate and transfer ions through the membrane; if the separator were not conductive to such a situation, then the electrolyte would not properly reside on and in the separator pores and the necessary ion transmission would not readily occur. In other words, generally the smaller the battery separator the better. Hence, providing a strong, thin, and dense structure would be highly desirable.

Battery separators have been provided to the industry having nano fiber constituents. Such structures allow, depending on manufacturing steps and procedures, a user to dial in a desired level of porosity with effective isotropic strength levels. Such separators are effective in terms of air resistance, as well, providing highly desirable structures within the lithium ion and other like battery markets. A drawback does exist, however, in terms of less than desired durability and resilience.

One procedure to manufacture nano fiber-based battery separators has been to utilize a melt-blowing process. In a type of melt-blowing, a nonwoven web is formed by extruding molten polymer through a die and then attenuating and breaking the resulting filaments with a hot, high-velocity gas stream. This process generates short, very fine fibers that can be collected on a moving belt where they bond with each other during cooling. Melt-blown webs can be made that exhibit very good barrier properties and can be utilized as battery separators.

Melt-blown fibers are most typically spun from polypropylene. Other polymers that have been spun as melt-blown fibers include polyethylene, polyamides, polyesters, and polyurethanes. Melt-blown fibers have been incorporated into a variety of nonwoven fabrics, including, for example, battery separators.

While existing nonwoven webs formed including melt-blown fibers have been used as battery separators, there is a desire for battery separators having improved physical resilience of the separator material to abrasion and puncture during the construction of a battery and in-service life. In addition, properties of such battery separator webs should be improved to increase rate and efficiency with which a battery separator wets out in the battery electrolyte, which would improve battery manufacture. Furthermore, such materials can be improved to achieve faster charging cycles, reduced energy consumption, and an extended battery life. Finally, the physical properties of such nonwovens should be improved to prevent or reduce the formation of dendrites and enhance resilience to puncture by dendrites.

### DETAILED DESCRIPTION OF THE EMBODIMENTS

All the features of this disclosure and its preferred embodiments will be described in full detail in connection with the following illustrative embodiments. In no manner has the description of the inventive battery separators, battery cells, and methods of manufacture therewith been made in any attempt to limit the scope thereof.

It should be noted that features described in connection with one exemplary embodiment or exemplary aspect may be combined with any other exemplary embodiment or exemplary aspect, in particular features described with any exemplary embodiment of a non-woven fabric may be combined with any other exemplary embodiment of a non-woven fabric and/or battery separator, with any exemplary embodiment of a method for producing a nonwoven fabric and/or battery separator, with any exemplary embodiment of a battery separator and with any exemplary embodiment of a use and vice versa, unless specifically stated otherwise.

Where an indefinite or definite article is used when referring to a singular term, such as “a”, “an”, or “the”, a plural of that term is also included and vice versa, unless specifically stated otherwise, whereas the word “one” or the number “1”, as used herein, typically means “just one” or “exactly one.”

The expression “comprising”, as used herein, includes not only the meaning of “comprising”, “including” or “containing”, but may also encompass “consisting essentially of” and “consisting of”.

Unless specifically stated otherwise, the expression “at least a part of”, as used herein, may mean at least 5% thereof, in particular at least 10% thereof, in particular at least 15% thereof, in particular at least 20% thereof, in particular at least 35% thereof, in particular at least 40% thereof, in particular at least 45% thereof, in particular at least 50% thereof, in particular at least 55% thereof, in particular at least 60% thereof, in particular at least 65% thereof, in particular at least 70% thereof, in particular at least 75% thereof, in particular at least 80% thereof, in particular at least 85% thereof, in particular at least 90% thereof, in particular at least 95% thereof, in particular at least 98% thereof, and may also mean 100% thereof.

In a first aspect, the present disclosure relates to a nonwoven material, for example, a battery separator, that has been coated and/or impregnated with inorganic oxides on one or both sides.

The tern “nonwoven fabric”, as used herein, may in particular mean a web of individual fibers which are at least partially intertwined, but not in a regular manner as in a knitted or woven fabric.

As noted above, the nonwoven fabric may be constructed from any polymer (or polymer blend) that accords suitable chemical and heat resistance in conjunction with internal battery cell conditions, as well as the capability to form suitable fiber structures within the ranges indicated, and further the potential to be treated through a fibrillation or like technique to increase the surface area of the fibers themselves for entanglement facilitation during nonwoven fabrication. Such fibers may be made from longstanding fiber manufacturing methods such as melt spinning, wet spinning, solution spinning, melt blowing, spunbonding, electrospinning, carding, and others. In addition, such fibers may begin as bicomponent fibers and have their size and/or shape reduced or changed through further processing, such as splitable pie fibers, islands-in-the-sea fibers, and others. Such fibers may be cut to an appropriate length for further processing, such lengths may be less than 1 inch, or less than ½ inch, or less than ¼ inch even. Such fibers may also be fibrillated into smaller fibers or fibers that advantageously form wet laid nonwoven fabrics.

In certain embodiments, the nonwoven fabric may be constructed from thermoplastic fibers. Suitable thermoplastic fibers include fibers comprising polypropylene, polyethylene terephthalate, nylon, polycaprolactam, polyphenylene sulfide, polyetherimide, and combinations thereof. The thermoplastic fibers can have an average fiber length of from 0.3 microns to 5 microns, or preferably, from 0.5 microns to 2 microns.

The nonwoven fabric of the present disclosure can contain nanofibers, which may be made through several longstanding techniques to make nanofibers. One example includes islands-in-the-sea, such as the Nano-Front fiber available from Teijin which are polyethylene terephthalate fibers with a diameter of 700 nm. Hills also makes and sells equipment that enables islands-in-the-sea nanofibers. Another example would be centrifugal spinning. Dienes and FiberRio are both marketing equipment when would provide nanofibers using the centrifugal spinning technique. Another example is electrospinning, such as practiced by DuPont, E-Spin Technologies, or on equipment marketed for this purpose by Elmarco. Still another technique to make nanofibers is to fibrillate them from film or from the fibers. Nanofibers fibrillated from films are disclosed in U.S. Pat. Nos. 6,110,588, 6,432,347, and 6,432,532, which are incorporated herein in their entirety by reference. Nanofibers fibrillated from other fibers may be done so under high shear, abrasive treatment. Nanofibers made from fibrillated cellulose and acrylic fibers are marketed by Engineered Fiber Technologies under the brand name EFTEC™. Any such nanofibers may also be further processed through cutting and high shear slurry processing to separate the fibers and enable them for wet laid nonwoven processing. Such high shear processing may or may not occur in the presence of the required microfibers.

Nanofibers that are made from fibrillation in general have a transverse aspect ratio that is different from one, such transverse aspect ratio described in full in U.S. Pat. No. 6,110,588. As such, in one preferred embodiment, the nanofibers have a transverse aspect ratio of >1.5:1, preferably >3.0:1, more preferably greater than 5.0:1.

As such, acrylic and polyolefin fibers are particularly preferred for such a purpose, with fibrillated acrylic fibers, are even more particularly preferred. Again, however, this is provided solely as an indication of a potentially preferred type of polymer for this purpose and is not intended to limit the scope of possible polymeric materials or polymeric blends for such a purpose.

One particular embodiment of the combination of microfiber and nanofibers is the EFTEC™ A-010-4 fibrillated polyacrylonitrile fibers, which have high populations of nanofibers as well as microfibers. By way of example, these fibers can be used as a base material, to which can be added further microfibers or further nanofibers as a way of controlling the pore size and other properties of the nonwoven fabric.

Novel enhanced nonwoven battery separators containing such above-described fibers can be further improved to increase durability and resilience both during battery manufacture and during the life cycle of the battery through coating and/or impregnation of the battery separator with inorganic oxides. Suitable inorganic oxides for coating and/or impregnating the nonwoven battery separator can be, for example, aluminum oxides, zinc oxides, silicon oxides, or combinations thereof. By coating and/or impregnating the nonwoven battery separator with inorganic oxides, the battery separator materials described herein can obtain a sheathing coating over the surface and internal porous structure of the substrate/web. Advantages of such a coating includes that that the coating does not detract from the high openness and transport potential of the separator, while at the same time, increasing the mechanical and thermal resilience. The coating, or sheathing, can further prevent oxidation and other interactions between the electrolyte and the underlying substrate to enhance both the electrochemical efficiency of the battery separator and its durability.

Treating battery separator materials with inorganic oxides, for example, ceramic and other coatings, can enhance the converting and in-service properties of the separators. For example, such treatment can improve physical resilience of the battery separator material to abrasion and puncture, both during construction of the battery and during the in-service life of the battery separator. In addition, such treatment can improve the rate and efficiency with which the battery separator wets out in the battery electrolyte. This improved efficiency contributes to efficiency gains in the manufacture of the battery. Further, the improved coating described herein can improve the rate at ion transit through the separator during charging of the battery. Faster charging cycles, reduced energy consumption and extended battery life are all achievable through the improved coatings. In addition, the coating/sheathing of the present disclosure over the nonwoven battery separator materials can result in additional prevention of the formation of dendrites and provide enhanced resiliency to puncture by dendrites. Furthermore, the present inventors have also recognized that the coating/sheathing can result in a reduction in the thermal shrinkage and thermal runaway vulnerability of the underlying polymer material making up the nonwoven, which is a known cause of, for example, lithium-ion battery failure and is a safety concern.

As described in further detail below, the film of resistant material applied onto the surface of battery separator material can coat the surface of the fibers and the interior pore structure as a sheathing coating. As used herein, a sheathing coating is a coating which thinly coats the fiber and internal pore surfaces without occluding or significantly narrowing the pores themselves.

As referenced above, nonwoven battery separators can be coated with inorganic oxides. In general, the thickness of the battery separator can be from approximately 10 microns to 30 microns. The sheathing coating described herein can have a thickness from few nanometers to a few microns, for example, from 5 nanometers to 10 microns. In addition, or alternatively, the sheathing coating can impregnate the porous nonwoven battery separator. The total amount of sheathing coating on the battery separator can also be in the range of 0.1% to 20% based on the total weight of the battery separator with the sheathing coating.

The nonwoven nanofiber battery separators can further contain pores having an average pore size of from 0.2 to 5 Microns and/or a porosity of from 30% to 60%. As referenced above, the sheathing coating can be deposited in the internal porous structure of the battery separator substrate/web. The sheathing coating described herein can coat the internal pore surfaces of the substrate and/or battery separator without occluding or significantly narrowing the pores themselves. By without occluding or significantly narrowing the pores themselves, it is meant that the mean porosity of the web changes by less than 20% as a result of this coating. The improved durability and resilience to mechanical damage result in battery separators having better physical properties, even at the minor occlusion or pore size.

As a result of coating a nonwoven battery separator with the inorganic oxides, as described herein, the resulting sheathing coated battery separator can have a mechanical strength that is at least 5% greater than the same battery separator without the sheathing coat, as measured by puncture resistance in gf. In some instances, it can be at least 10% greater than the same battery separator without the sheathing coating. In other embodiments it can be at least 15% greater, 20% greater, or even at least 25% greater.

The sheathing coated battery separators described herein can further be included in batteries, for example, in rechargeable batteries. In one embodiment, the battery separators described herein can be included in a lithium-ion battery. In another embodiment, the battery separators described herein can be included in an automotive battery.

The battery separators of the present disclosure can have the deposited and/or impregnated sheathing coating applied in several methods. Battery separators of the present disclosure can obtain the deposited and/or impregnated sheathing coating in several methods. As one example, the sheathing coating can be applied to the substrate/web, for example, of a battery separator, by a physical vapor deposition or a chemical vapor deposition process. Based on the desired properties of the end use, the sheathing coating can be applied to one side or both sides of the battery separator substrate/web. In addition, as described in further detail below, the sheathing coating can be applied solely to the surface of the nonwoven substrate/web and/or impregnate the porous structure of the nonwoven substrate/web.

When depositing the inorganic oxides described herein on the battery separator substrate/web, there are numerous approaches to achieve the deposition. However, and without desiring to be bound by any particular mechanism, an objective is to deposit a thin film of resilient material onto the external and internal pore network surfaces of the substrate in a manner such that the inorganic oxide adheres strongly. Furthermore, the deposition cannot be in a manner where the pores are occluded such that a battery having the treated nonwoven battery separator cannot function.

Physical vapor deposition processes have the benefit of relative ease of use and relatively high productivity; however, their ability to coat the internal surfaces of a porous material are limited because physical vapor deposition operates on a line-of-sight basis. However, these limitations may be overcome through surface activation techniques such as plasma etching. Moreover, two-sided application of the coatings to the substrate can be achieved and create beneficial performance in the battery separator.

Generally, physical vapor deposition operates under conditions of significant vacuum where coating material, e.g., the inorganic sheathing material described herein, can be sublimated from a solid to a vapor state by application of heat. The heat can be applied, for example, in the form of electrical resistance heating, radio-frequency ablation, through the use of a laser, or any other known heating methods for physical vapor deposition. The vapor created can then be collected onto the surface of the object or substrate that is being coated, for example, a substrate/web and/or a nonwoven battery separator. The substrate or object being coated can be static racks of components, technical foils, films, or membranes that the coating is applied to and can be applied to a running web in a roll-to-roll configuration. In other methods, the vapor coating can be deposited directly onto a stationary substrate or object to be coated. If desired, wetting and adhesion of the coating material can be optimized by preparing the surface by chemical or physical means. For example, the surface(s) to be coated can be prepared by a chemical pre-coat or etchings. Alternatively, or in addition, the surface(s) to be coated can be prepared through physical means, such as, plasma treatment or corona discharge.

When utilizing physical vapor deposition to manufacture the sheathing coated battery separators of the present disclosure, metallic, e.g., inorganic components, can be converted into their oxides by blending a controlled quantity of pure oxygen into the metal vapor as it leaves the evaporator such that it reacts to form the metallic, e.g., inorganic, oxides as the coating material is deposited onto the substrate/web and/or battery separator. The degree of oxidation and hence the mechanical and electrical properties of the coated substrate can be tuned by managing the flow of oxygen into the metal vapor.

During the physical vapor deposition process, certain parameters can be adjusted to achieve the desired mechanical and electrical properties of the coated substrate. For instance, the level of oxygen used in preparation of the metallic oxides for the sheathing coating for the nonwoven materials. In addition, the degree of oxidation can adjust the end properties.

As an example, a thermal evaporation coating of aluminum oxide can be applied to the surface(s) of the nonwoven substrates described herein. Aluminum is vaporized under conditions of high vacuum and allowed to oxide within the vacuum. Subsequently, the aluminum oxide coating is deposited on one or both sides of the substrate, for example, a battery separator material. In certain embodiments, the aluminum oxide can impregnate the porous structure of the battery separator material, without fully occluding the pores of the nonwoven structure.

Alternatively, chemical vapor deposition can also be utilized to apply the sheathing coating to the battery separator web/substrate. Generally, chemical vapor deposition processes can be very specialized and slow in operation; therefore, in certain situations it may not be economically feasible to deposit the inorganic coating through chemical vapor deposition. However, as a benefit, chemical vapor deposition provides a superior ability to deliver the inorganic coating material into the internal pore structure, e.g., beyond line of sight, and can achieve a superior product.

As described herein, chemical vapor deposition includes the generation of a vapor phase of chemical precursors. Optionally, the process can include a vacuum to deposit the vapor phase on the substrate. Upon deposition, the chemical precursors react with the substrate and, if desired, subsequent precursor applications to modify the surface and pores. The reaction can further increase adhesion of the inorganic materials to the surface and pores of the substrate. By controlling the amount and length of time of the chemical deposition, a suitable thickness of sheathing coating material can be deposited on the substrate.

Although the embodiments have been described, it will readily be appreciated by those skilled in the art that many modifications and adaptations of the compositions, devices, and processes described herein are possible without departure from the spirit and scope of the embodiments as claimed. Thus, it is to be clearly understood that this description is made only by way of example and not as a limitation on the scope.

What is claimed is:

1. A battery separator comprising:
a nonwoven material comprising at least one inorganic oxide.

2. The battery separator of claim 1, wherein the at least one inorganic oxide is at least partially located on a first outer surface of the nonwoven material.

3. The battery separator of claim 2, wherein the at least one inorganic oxide is at least partially located on a second outer surface of the nonwoven material.

4. The battery separator of claim 1, wherein the at least one inorganic oxide is at least partially impregnated in the nonwoven material.

5. The battery separator of claim 1, wherein the at least one inorganic oxide is selected from the group consisting of an aluminum oxide, a zinc oxide, and combinations thereof.

6. The battery separator of claim 2, wherein a thickness of the at least one inorganic oxide is from 5 nanometers to 10 microns.

7. The battery separator of claim 1, wherein the battery separator comprises from 0.1% to 20% by weight of the at least one inorganic oxide.

8. The battery separator of claim 1, wherein the nonwoven material comprises an average pore size of from 0.2 to 5 microns and a porosity of from 30% to 60%.

9. The battery separator of claim 8, wherein the inorganic oxide reduces the porosity of the nonwoven material by less than 20%.

10. The battery separator of claim 1, wherein the nonwoven material comprises thermoplastic fibers.

11. The battery separator of claim 10, wherein the thermoplastic fibers comprise an average fiber length of from 0.3 microns to 5 microns.

12. The battery separator of claim 10, wherein the thermoplastic fibers are selected from fibers comprising polypropylene, polyethylene terephthalate, nylon, polycaprolactam, polyphenylene sulfide, polyetherimide, and combinations thereof.

13. The battery separator of claim 1, wherein the nonwoven material comprises fibers selected from a group consisting of melt blown, spunbond, electrospun, carded fibers, and combinations thereof.

14. A method of manufacturing a battery separator, comprising:
applying at least one inorganic oxide to at least one outer surface of a nonwoven material.

15. The method of claim 14, further comprising impregnating the nonwoven material with the at least one inorganic oxide.

16. The method of claim 14, wherein the battery separator comprises from 0.1% to 20% by weight of the at least one inorganic oxide.

17. The method of claim 14, wherein the at least one inorganic oxide is selected from the group consisting of an aluminum oxide, a zinc oxide, and combinations thereof.

18. The method of claim 14, wherein the application of the inorganic oxide to the nonwoven material does not reduce the porosity of the nonwoven material more than 20%.

19. The method of claim 14, wherein physical vapor deposition is used to apply the at least one organic oxide to the nonwoven material.

20. The method of claim 14, wherein chemical vapor deposition is used to apply the at least one organic oxide to the nonwoven material.

21. The method of claim 14, wherein the nonwoven material comprises thermoplastic fibers.

22. The method of claim 21, wherein the thermoplastic fibers comprise an average fiber length of from 0.3 microns to 5 microns.

23. The method of claim 21, wherein the thermoplastic fibers are selected from fibers comprising polypropylene, polyethylene terephthalate, nylon, polycaprolactam, polyphenylene sulfide, polyetherimide, and combinations thereof.

24. The method of claim 14, wherein the nonwoven material comprises fibers selected from a group consisting of melt blown, spunbond, electrospun, carded fibers, and combinations thereof.

25. A lithium-ion battery and/or automotive battery comprising the battery separator of claim 1.
